(19) United States
(12) Patent Application Publication
(10) Pub. No.: US 2026/0336320 A1
(43) Pub. Date: Oct. 29, 2026

(54) Deep Reach Marker Pen with Grip Sleeve

(71) Applicant: Milwaukee Electric Tool Corporation, Brookfield, WI (US)

(72) Inventor: Thomas J. Schneider, Milwaukee, WI (US)

(21) Appl. No.: 19/562,045

(22) Filed: Mar. 10, 2026

Related U.S. Application Data
(60) Provisional application No. 63/793,134, filed on Apr. 23, 2025.

(51) Int. Cl. B43K 1/00; B43K 23/12

(52) U.S. Cl. CPC B43K 1/00; B43K 23/12

(57) ABSTRACT

A writing implement with a capping structure, including an outer cap and a grip sleeve, is provided. An elongate nib extends from the first end of the body of the writing implement and includes a tip. A first length is defined between the tip and the first end of the body. The writing implement further includes a capping structure. The grip sleeve surrounds the elongate nib and includes a tip end facing the tip of the elongate nib and an attachment end opposite the tip end. The attachment end is coupled to the first end of the body. A second length is defined between the tip of the elongate nib and the tip end. The second length is less than the first length.

### CROSS-REFERENCE TO RELATED PATENT APPLICATION

The present application claims the benefit of and priority to U.S. Provisional Application No. 63/793,134 filed on Apr. 23, 2025, which is incorporated herein by reference in its entirety.

### BACKGROUND OF THE INVENTION

The present invention relates generally to the field of writing implements. The present invention relates specifically to a deep reach marker pen with an elongate nib.

### SUMMARY OF THE INVENTION

One embodiment of the invention relates to a writing implement. The writing implement includes a body with a first end and a second end opposite the first end along a longitudinal axis. An elongate nib extends from the first end of the body in a direction along the longitudinal axis away from the first end of the body and away from the second end of the body. The elongate nib includes a tip. A first length is defined between the tip and the first end of the body. The writing implement further includes a capping structure. The capping structure includes a sleeve removably coupled to the first end of the body, and a cap removably coupled to the sleeve. The sleeve surrounds the elongate nib and includes a tip end facing the tip of the elongate nib and an attachment end opposite the tip end. The attachment end is coupled to the first end of the body. A second length is defined between the tip of the elongate nib and the tip end. The second length is less than the first length.

Another embodiment of the invention relates to a marker pen. The marker pen includes a body, a nib, and a sleeve. The body includes a first end and a second end opposite the first end along a longitudinal axis. The nib extends from the first end of the body. The nib includes a tip spaced away from the first end of the body by a first distance in a direction along the longitudinal axis. The sleeve is configured to removably couple to the body. When the sleeve is coupled to the first end of the body, an end of the sleeve is spaced from the first end of the body along the longitudinal axis. The end circumferentially surrounds the nib and faces the tip of the nib. When the sleeve is coupled to the first end of the body, a second distance is defined between the tip of the nib and the end of the sleeve. The second distance is less than the first distance.

Another embodiment of the invention relates to a deep-reach marker. The deep reach marker includes a body, a nib, and a sleeve. The body extends along a longitudinal axis. The body includes a first end and a second end opposite the first end along the longitudinal axis. The nib extends away from the first end of the body and away from the second end of the body. The nib includes a tip and a mounting end opposite the tip in a direction along the longitudinal axis. The mounting end is retained within the body. The sleeve is removably coupled to the first end of the body. The sleeve includes a tip end and an attachment end opposite the tip end along the longitudinal axis. A first distance is defined between the tip of the nib and the first end of the body. A second distance is defined between the tip of the nib and the tip end of the sleeve. The second distance is less than the first distance.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a marker pen, according to an exemplary embodiment;

FIG. 2 is a partial exploded view of the marker pen of FIG. 1, according to an exemplary embodiment;

FIG. 3 is a detailed cross-sectional view of a first end of the marker pen of FIG. 1, according to an exemplary embodiment;

FIG. 4 is a side view of the marker pen of FIG. 1 in a first position with the cap on the back end of the marker pen, according to an exemplary embodiment; and

FIG. 5 is a side view of the marker pen of FIG. 1 in a second position with the cap and the sleeve on the back end of the marker pen, according to an exemplary embodiment.

### DETAILED DESCRIPTION

Referring generally to the figures, various embodiments of a writing implement (e.g., a deep-reach marker pen, an elongated pen, a marker pen, a permanent marker, a jobsite pen, etc.) with an elongate nib (i.e., a long and thin nib) are shown. Conventional writing implements with elongate nibs are typically used for writing in tight spaces and marking within deep holes due to the nib having a deeper reach than other writing implements. However, Applicant has identified that when a user uses a conventional writing implement with elongate nib in situations where an elongated nib is not needed (e.g., in non-narrow or non-deep locations), the user may be uncomfortable or may have less precision when writing due to the grip location for the user being spaced further from the tip of the nib than a standard pen or marker, which have a short distance between the tip of the nib and the grip location.

In contrast to conventional writing implements with elongate nibs, the writing implements discussed herein include a two-part capping structure with a cap and an ergonomic sleeve. The ergonomic sleeve surrounds the elongate nib and provides a gripping location adjacent to the tip of the elongate nib, which allows the user to conveniently hold the writing implement for writing when not writing in deep or narrow situations. When a user needs to use writing implement in a situation where the elongate nib is needed, then the sleeve and the cap may be removed and mounted at a rear end of the writing implement.

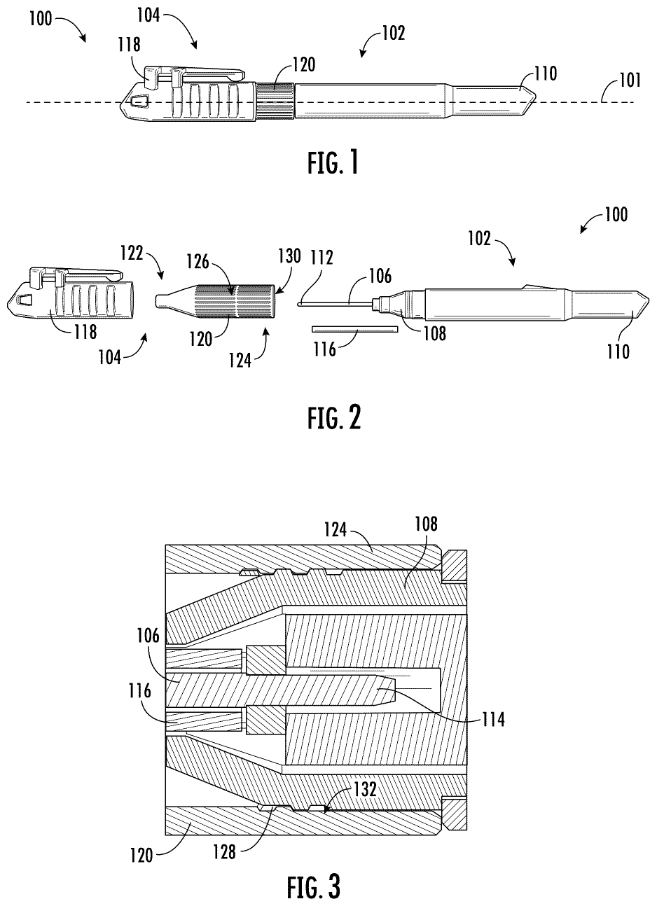

Referring to FIGS. 1-3, a writing implement, shown as marker pen 100, is shown and described. Marker pen 100 includes a body 102, a capping structure 104, and a nib 106. As shown, nib 106 is an elongate nib or deep-reach nib. Body 102 extends along and is centered on a longitudinal axis 101. Body 102 includes a first end or front end 108 and a second end or rear end 110 opposite front end 108 along longitudinal axis 101. Body 102 defines a cavity between front end 108 and rear end 110. The cavity is configured to contain a liquid marking material or solution (e.g., ink, etc.).

Nib 106 is configured to dispense marking material (e.g., ink) from the cavity of body 102 onto a workpiece. Nib 106 extends through front end 108 of body 102. Nib 106 is centered on longitudinal axis 101. Nib 106 extends away from front end 108 and rear end 110 of body 102 in a direction along longitudinal axis 101. Nib 106 includes a tip 112 and a mounting end 114 opposite tip 112 along longitudinal axis 101. Mounting end 114 is coupled to body 102, and is surrounded by front end 108 of body 102. In particular, mounting end 114 is received and retained in an opening defined in front end 108 of body 102. A length of nib 106 is defined between tip 112 and mounting end 114 along longitudinal axis 101. In a specific embodiment, the length of nib 106 is between 45 mm and 50 mm, and, more specifically, is 48.5 mm. In another specific embodiment, the ratio of length of nib 106 to the diameter of top 112 of nib is at least 30:1. In a specific embodiment, nib 106 is made from Polymethyl methacrylate (PMMA).

As shown, a support tube 116 is positioned around a portion of nib 106 between tip 112 and mounting end 114. Support tube 116 is used to provide additional support to nib 106 along its length. In a specific embodiment, support tube 116 is a metal tube. In various embodiments, a user may slide support tube 116 along the length of nib 106 to adjust an exposed length of nib 106. This allows users to cut or nib 106 when tip 112 frays. The exposed length of nib 106 is a distance defined between tip 112 and support tube 116. In a specific embodiment, the exposed length is between 2 mm and 4 mm, and more specifically is 2.3 mm.

Capping structure 104 is removably coupled to body 102. Capping structure 104 is configured to cover nib 106. Capping structure 104 includes an outer cap 118 and a grip sleeve 120. Outer cap 118 is removably coupled to sleeve 120 and is configured to cover tip 112 of nib 106 when marker pen 100 is not in use. In a specific embodiment, outer cap 118 is removably coupled to sleeve 120 via a snap-fit connection or interference fit. In a specific embodiment, bumps or projections formed along an inner surface of capping structure 118 interface with bumps or projections formed along an outer surface of grip sleeve 120 to create an interference fit between outer cap 118 and grip sleeve 120.

Sleeve 120 is removably coupled to front end 108 of body 102 and surrounds nib 106. When coupled to front end 108 of body 102, sleeve 120 defines a gripping location close to tip 112 of nib 106. Sleeve 120 includes a first end or tip end 122 facing tip 112 of nib 106 when sleeve 120 is mounted on front end 108, and a second end or attachment end 124 opposite tip end 122 along longitudinal axis 101 when sleeve 120 is coupled to body 102. Attachment end 124 is coupled to front end 108 of body 102. Sleeve 120 also includes a gripping surface or an outer surface 126 that extends between tip end 122 and attachment end 124. An inner surface 128 faces opposite outer surface 126 and defines a channel 130. When mounted on front end 108, nib 106 extends through channel 130 and is surrounded by outer surface 126 of sleeve 120, and tip end 122 is positioned adjacent to tip 112 such that sleeve 120 defines a gripping location for a user adjacent to tip 112 of nib 106.

Referring to FIG. 3, sleeve 120 is removably coupled to front end 108 of body 102 via threading. As shown, front end 108 includes external threading formed along an external surface 132 of front end 108. Attachment end 124 includes internal threading formed along inner surface 128 of attachment end 124. The internal threading of attachment end 124 of sleeve 120 is configured to securely couple to the external threading of front end 108 of body 102.

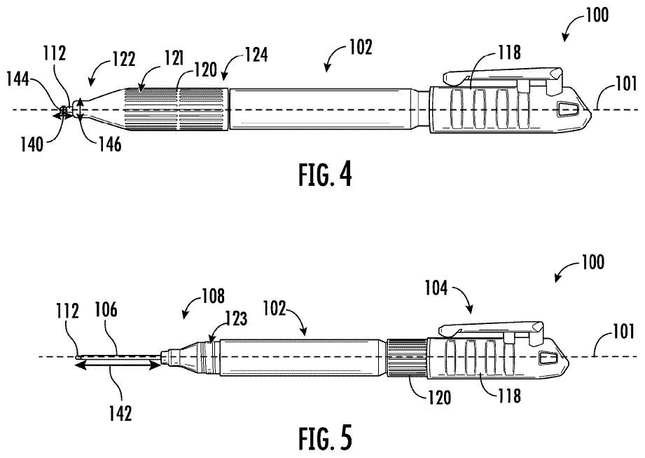

Referring to FIG. 4, marker pen 100 is shown in a first writing position with outer cap 118 disconnected from sleeve 120. Outer cap 118 is mounted on rear end 110 of body 102. Sleeve 120 is coupled to front end 108. When in this first writing position, marker pen 100 is configured to be held at a grip location adjacent to tip 112 of nib 106. In particular, sleeve 120 defines an outer surface or grip surface 121 configured to be held by a user when the user is writing with marker pen 100. Applicant believes that this configuration allows a user to conveniently hold marker pen 100 for writing in situations that do not require an elongate nib (e.g., not narrow, not deep, etc.). As shown, a first distance 140 is defined between tip 112 and tip end 122 along longitudinal axis 101. First distance 140 is a first length measured along the length of elongate nib 106 between tip 112 and tip end 122. In a specific embodiment, first distance 140 is at most 6 mm and at least 2 mm. In a more specific embodiment, first distance 140 is 4 mm.

Sleeve 120 defines an increasing width of diameter of marker pen 100 adjacent to tip 112 of nib 106. As shown, tip 112 defines a first width or first diameter 144 and tip end 122 defines a second width or second diameter 146. First diameter 144 is measured perpendicular to longitudinal axis 101. When sleeve 120 is coupled to front end 108 of body 102, tip end 122 is positioned along the length of nib 106 between tip 112 and mounting end 114. Second diameter 146 is defined by tip end 122 along the length of nib 106 and is measured perpendicular to longitudinal axis 101. Second diameter 146 is greater than first diameter 144. In a specific embodiment, first diameter 144 is between 1 mm and 2 mm, and more specifically is 1.5 mm.

Referring to FIG. 5, marker pen 100 is shown in a second writing position with capping structure 104 mounted on rear end 110 of body 102. Outer cap 118 is coupled to sleeve 120, and attachment end 124 of sleeve 120 is coupled to rear end 110. In this way, sleeve is detached from front end 108 of body 102. When in this second writing position, marker pen 100 is configured to be used to write/mark in deep and/or narrow locations (e.g., within a hole). As shown, front end 108 of body 102 includes a tapered shape and defines a grip location spaced a distance from tip 112 of nib 106. In particular, front end 108 defines an outer surface or grip surface 123 configured to be held by a user when the user is writing with marker pen 100. Grip surface 123 is located further from tip 112 than grip surface 121 is located from tip 112 in a direction along longitudinal axis 101. That is, grip surface 121 is located closer to tip 112 than grip surface 123 is located to tip 112.

A second distance 142 is defined between tip 112 and front end 108 of body 102 along longitudinal axis 101. Second distance 142 is a second length defined along the length of elongate nib 106 between tip 112 and front end 108. Second distance 142 is greater than first distance 140. That is, first distance 140 is less than second distance 142. As shown, first diameter 144 is less than first distance 140 and less than second distance 142. In a specific embodiment, second distance 142 is at least 20 mm and at most 35 mm. In a more specific embodiment, second distance 142 is at least 25 mm and at most 30 mm, and more specifically is 29.3 mm. In a specific embodiment, the ratio of first distance to second distance is at least 1:5, and more specifically at least 1:7.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles, and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A writing implement, comprising:
a body comprising a first end and a second end opposite the first end along a longitudinal axis;
an elongate nib extending from the first end of the body in a direction along the longitudinal axis away from the first end of the body and away from the second end of the body, the elongate nib comprising a tip, wherein a first length is defined between the tip and the first end of the body; and
a capping structure, comprising:
a sleeve removably coupled to the first end of the body and surrounding the elongate nib, the sleeve including a tip end facing the tip of the elongate nib and an attachment end opposite the tip end, the attachment end coupled to the first end of the body; and
a cap removably coupled to the sleeve;
wherein a second length is defined between the tip of the elongate nib and the tip end, wherein the second length is less than the first length.

2. The writing implement of claim 1, wherein the tip end of the sleeve has a diameter greater than the diameter of the tip such that the sleeve defines a gripping location along the tip end for a user to hold the writing implement.

3. The writing implement of claim 1, wherein the sleeve is coupled to the first end of the body via threading.

4. The writing implement of claim 3, wherein the sleeve comprises internal threading formed along an inner surface of the attachment end, and the body comprises external threading formed along an external surface of the first end of the body, and wherein the internal threading is configured to securely and removably couple to the external threading.

5. The writing implement of claim 1, wherein the cap is removably coupled to the sleeve via a snap-fit connection.

6. The writing implement of claim 1, wherein the elongate nib has a width measured perpendicular to the longitudinal axis that is less than the first length and less than the second length.

7. The writing implement of claim 1, wherein the body defines a cavity configured to hold a liquid marking material.

8. The writing implement of claim 7, wherein a mounting end of the elongate nib is received and retained in an opening defined in the first end of the body, and wherein the elongate nib is configured to dispense the liquid marking material from the cavity onto a workpiece.

9. The writing implement of claim 1, further comprising a tube surrounding a portion of the elongate nib between the tip and a mounting end of the elongate nib opposite the tip along the longitudinal axis.

10. A marker pen, comprising:
a body comprising a first end and a second end opposite the first end along a longitudinal axis;
a nib extending from the first end of the body, the nib comprising a tip spaced away from the first end of the body by a first distance in a direction along the longitudinal axis; and
a sleeve configured to removably couple to the body;
wherein, when the sleeve is coupled to the first end of the body, an end of the sleeve spaced from the first end of the body along the longitudinal axis and the end circumferentially surrounds the nib and faces the tip of the nib; and
wherein, when the sleeve is coupled to the first end of the body, a second distance is defined between the tip of the nib and the end of the sleeve, wherein the second distance is less than the first distance.

11. The marker pen of claim 10, wherein, when the sleeve is detached from the first end of the body, a first grip surface is defined along the first end of the body configured to be held by a user when writing with the marker pen.

12. The marker pen of claim 11, wherein when the sleeve is coupled to the first end of the body, a second grip surface is defined along the end of the sleeve configured to be held by a user when writing with the marker pen.

13. The marker pen of claim 12, wherein the second grip surface is located closer to the tip of the nib than the first grip surface.

14. The marker pen of claim 10, further comprising a cap removably coupled to the sleeve.

15. The marker pen of claim 10, wherein the sleeve comprises internal threading formed along an inner surface of the sleeve, and the body comprises external threading formed along an external surface of the first end of the body, and wherein the internal threading is configured to securely and removably couple to the external threading.

16. A deep-reach marker, comprising:
a body extending along a longitudinal axis, the body comprising a first end and a second end opposite the first end along the longitudinal axis;
a nib extending away from the first end of the body and away from the second end of the body, the nib comprising a tip and a mounting end opposite the tip in a direction along the longitudinal axis, the mounting end retained within the body; and
a sleeve removably coupled to the first end of the body, the sleeve comprising a tip end and an attachment end opposite the tip end along the longitudinal axis;
wherein, a first distance is defined between the tip of the nib and the first end of the body and a second distance is defined between the tip of the nib and the tip end of the sleeve;
wherein the second distance is less than the first distance.

17. The deep-reach marker of claim 16, wherein the sleeve comprises internal threading formed along an inner surface of the attachment end of the sleeve, and the body comprises external threading formed along an external surface of the first end of the body, wherein the internal threading is configured to securely and removably couple to the external threading.

18. The deep-reach marker of claim 16, wherein the tip end of the sleeve has a diameter greater than the diameter of the tip such that the sleeve defines a gripping surface along the tip end for a user to hold the deep-reach marker.

19. The deep-reach marker of claim 16, wherein the nib has a width measured perpendicular to the longitudinal axis that is less than the first distance and less than the second distance.

20. The deep-reach marker of claim 16, further comprising a cap removably coupled to the sleeve.
